(19) United States
(12) Patent Application Publication
(10) Pub. No.: US 2003/0168855 A1
(43) Pub. Date: Sep. 11, 2003

(54) Receiving part of a fluid plug-in coupling

(76) Inventors: Volker Kaminski, Halver (DE); Jannis Serdaris, Gummersbach (DE); Norbert Terlau, Kurten (DE); Frank Zenses, Hurth (DE)

Correspondence Address: Steven L. Oberholtzer, Esq., BRINKS HOFER GILSON & LIONE, P.O. Box 10395, Chicago, IL, 60610, US

(21) Appl. No.: 10/355,362

(22) Filed: Jan. 31, 2003

(30) Foreign Application Priority Data
Feb. 2, 2002 (DE) 202 01 573.4

(51) Int. Cl. F16L 39/00

(52) U.S. Cl. 285/319

(57) ABSTRACT

The present invention relates to a receiving part of a fluid plug-in coupling. The receiving part comprises a socket housing having a plug-in opening for a plug part and a retaining device for releasably fixing the plug part in place. The retaining device has a retaining element which is mounted in the socket housing and has one or more radially elastically deformable retaining sections for latching engagement behind a radial retaining step of the plug part. A release element is secured in an axially displaceable manner relative to the socket housing. The release element engages by means of an inner release section in the plug-in opening and, for release purposes, acts against the retaining sections of the retaining element. Latching means for securing the release element are provided on the outer circumference of the socket housing.

### BACKGROUND OF THE INVENTION

The present invention relates to a receiving part of a fluid plug-in coupling (fluid is to be understood as meaning any hydraulic or gaseous flow medium), comprising a socket housing having a plug-in opening for a plug part and a retaining device for releasably fixing the plugged-in plug part in place. The retaining device also has a retaining element which is mounted in the socket housing and includes radially elastically deformable retaining sections for latching engagement behind a radial retaining step of the plug part. The retaining device also includes a release element which is secured in an axially displaceable manner relative to the socket housing via latching means, the release element engaging by means of an inner release section in the plug-in opening and, for release purposes, acting against the retaining sections of the retaining element.

EP 0 727 027 B1 describes a quick-connect coupling of this type, in which the release element comprises an inner sleeve and an outer sleeve. As a release section, the inner sleeve acts against the retaining sections of the retaining element. In this case, latching projections are also formed on the inner sleeve. The latching projections extend radially outward and interact with an inner annular edge of the socket housing. The release element is designed as a shaped plastic part, it hence being difficult due to the design of the latching means, to produce the latching projections in terms of shape because this region is actually coaxially enclosed by the outer sleeve. The outer sleeve therefore has, in the regions radially covering the latching projections, slots for a shaping tool for shaping the latching projections. As a result, the outer sleeve is subdivided into a plurality of sleeve regions which are separated by the slots and are connected at one end to the inner sleeve as a single piece. The outer sleeve serves as a finger gripping surface which for this purpose, is of slightly concavely curved design as seen in the axial direction.

### SUMMARY OF THE INVENTION

The present invention is based on the object of providing a coupling receiving part of the type mentioned which can be produced simply and cost-effectively in the region of the release element, and nevertheless ensures reliable functioning.

According to the invention, the above mentioned object is achieved by the latching means securing the release element being provided on the outer circumference of the socket housing. In the case of a preferred design of the release element as a shaped plastic part, the invention enables the latching means to be produced in a simple manner and by means of a cost-effective forming tool. For this purpose, it is particularly advantageous if the latching means comprise firstly, an outer, radial latching step of the socket housing and secondly, at least two radially resilient latching arms of the release element, which latching arms are distributed in a radially symmetrical manner over the circumference and engage axially over the socket housing and its latching step. The latching arms, with latching lugs projecting radially inward at their free ends, can be formed in a simple manner and can also be removed from the mold through “forced removal from the mold” by elastically deforming the latching arms.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 shows an axial section of a plug-in coupling in a first embodiment of the receiving part with plugged-in plug part,

FIG. 2 shows an illustration similar to FIG. 1 in a second embodiment of the receiving part,

FIG. 3 shows a side view of the release element, the view being reduced in size in comparison with FIG. 2 (view in the arrow direction III according to FIG. 2).

FIG. 4 shows a section in the plane IV-IV according to FIG. 3,

FIG. 5 shows an illustration similar to FIG. 3 in a design variant of the release element,

FIG. 6 shows a section in the plane VI-VI according to FIG. 5,

FIG. 7 shows a separate sectional view corresponding to FIGS. 1 and 2 of the retaining element,

FIG. 8 shows an axial view in the arrow direction VIII according to FIG. 7,

FIG. 9 shows a section in the plans IX-IX according to FIG. 8,

FIG. 10 shows a separate, enlarged sectional view of an individual part, i.e. of a sealing closing bushing, and

FIG. 11 shows an axial end view in the arrow direction XI according to FIG. 10.

### DETAILED DESCRIPTION OF THE PREFERRED EMBODIMENT

In the various figures of the drawings, identical parts are always provided with the same reference numbers.

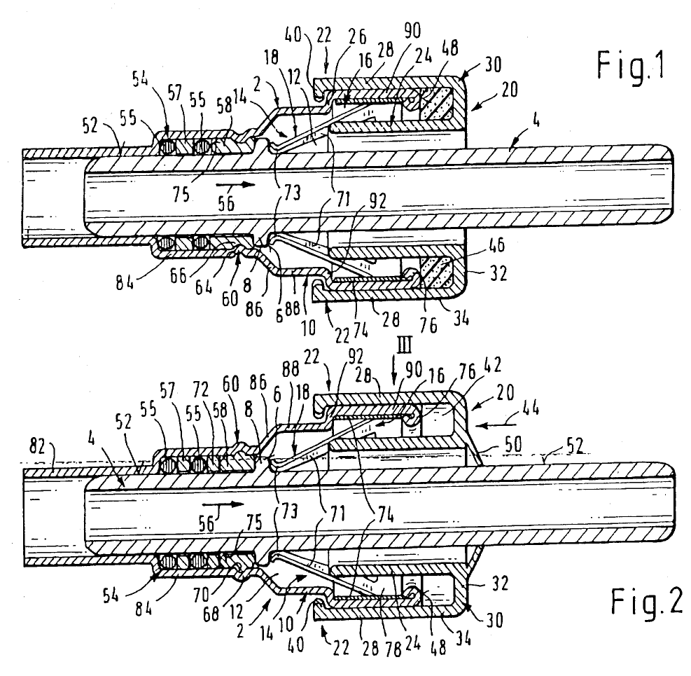

As emerges initially from FIGS. 1 and 2 in each case, a plug-in coupling comprises a receiving part 2 and a plug part 4. However, the invention relates only to the receiving part 2, while the plug part 4 has a standard design (“SAE plug”) in the form of a section of pipe which has an annular projection 8 so as to form a radial retaining step 6 on its outer circumference.

The receiving part 2 comprises a socket housing 10 having a plug-in opening 12 for the plug part 4, and having a retaining device 14 for releasably fixing the plugged-in plug part 4 in place. For this purpose, the retaining device 14 has a retaining element 16 which is mounted in the socket housing 10. This retaining element 16, compare in this respect also the separate illustrations in FIGS. 7 to 9, for its part having radially elastically deformable retaining sections 18 for latching engagement behind the retaining step 6 of the plug part 4. The receiving part 2 furthermore has a release element 20 which is secured in an axially displaceable manner relative to the socket housing 10 via latching means 22. In this case, the release element 20 engages by means of an inner release section 24 in the plug-in opening 12 and, for the purpose of releasing the locked plug part 4, acts here against the retaining sections 18 of the retaining element 16.

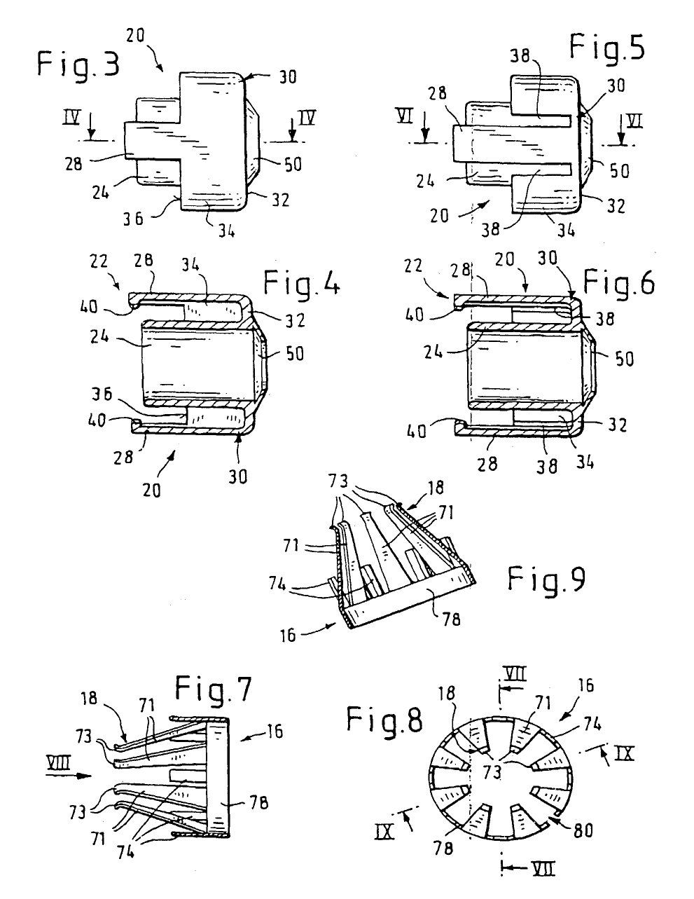

According to FIGS. 1 and 2, the latching means 22, which captively secure the release element 20 on the socket housing 10, are provided according to the invention, on the outer circumference of the socket housing 10. For this purpose, the latching means 22 comprise firstly, an outer, radial latching step 26 of the socket housing 10 and, secondly, resilient latching arms 28 of the release element 20. In the case of the embodiment illustrated, two diametrically opposite latching arms 28 are provided. However, there may also be a greater number of latching arms 28 in an arrangement which is preferably radially symmetrical. The latching arms 28 engage axially over the outside of the socket housing 10 and the latching step 26. Reference is also made in addition to FIGS. 3 to 6. The release element 20 is accordingly preferably formed as a single-piece shaped plastic part. The release section 24, which is preferably designed as a hollow cylindrical inner sleeve, is connected as a single piece to the latching arms 28 via a transition section 30. This transaction section 30 comprises an end section 32 which emerges radially from the sleeve-shaped, hollow cylindrical release section 24, is essentially in the shape of an annular disk, and preferably merges into a hollow cylindrical circumferential section 34 which coaxially surrounds the release section 24 at a radial distance. In the embodiment illustrated, the circumferential section 34, which is therefore likewise sleeve-shaped, extends axially approximately over half of the axial length of the hollow cylindrical release section 24. Reference is made in this respect to FIGS. 4 and 6.

In the embodiment of the release element 20 illustrated in FIGS. 3 and 4, the circumferential section 34 merges at its end edge 36 which points away from the end section 32 into the latching arms 28. In this design, the latching arms 28 therefore have a relatively short axial length which is somewhat larger than half of the axial length of the release section 24.

In the case of the design variant illustrated in FIGS. 5 and 6, the circumferential section 34 has axial slots 38 on both sides of each latching arm 28 in such a manner that the latching arms 28 are extended, with regard to their effective spring length, in the direction of the end section 32. In the case of the design illustrated, the latching arms 28 emerge directly from the end section 32.

In both cases, the latching arms 28 have, at their free ends, radially inwardly projecting latching lugs 40 which interact with the outer latching step, 26 of the socket housing 10 in a form-fitting manner or at least in a frictional manner. Furthermore, the outer latching arms 28 protrude over the inner release section 24 in the axial direction at least by the length of the latching lugs 40, this permitting particularly simple shaping in terms of the plastic.

According to FIG. 2, a clearance 42 is formed in the region of the transition section 30 between the release element 20 and the socket housing 10 in a manner that the axial movability of the release element 20 is ensured. In an advantageous refinement, a spring element can be arranged within the clearance 42 in such a manner that the release element 20 can be moved out of a spring-induced inoperative position (as illustrated in each case in FIGS. 1 and 2) into its release position in the arrow direction 44 counter to spring force. Furthermore, a sealing element can also be arranged within the clearance 42, in particular for sealing against the penetration of dirt, moisture and the like into the region of the retaining element 16. In this case, provision is made in the preferred design according to FIG. 1 for the spring element and the sealing element to be formed from a single annular element 46 consisting of an elastically deformable material, preferably cellular rubber or the like. The annular element 46 fills the entire clearance 42, with the result that it is supported on the inside, firstly, on the end section 32 of the release element 20 and, secondly, on a mouth-side opening edge 48 of the socket housing 10.

In a further advantageous refinement according to FIGS. 2 to 6, provision is made for the release element 20 to have a radial sealing lip 50 so as to circumferentially support it on a circumferential surface 52 of the plugged-in plug part. In this case, this sealing lip 50 is designed to be flexible and elastic in such a manner that the plug part together with its annular projection 8, which has the retaining step 6, can pass the sealing lip 50 without obstruction. The sealing lip 50 is preferably formed integrally as a single piece approximately in the transition region between the release section 24 and the end section 32.

Furthermore, according to FIGS. 1 and 2, a sealing arrangement 54 for circumferentially sealing the plugged-in plug part 4 on the outer circumference 52 is arranged within the socket housing 10. In the designs illustrated, the sealing arrangement 54 comprises two sealing rings 55 and a spacer ring 57 arranged between them.

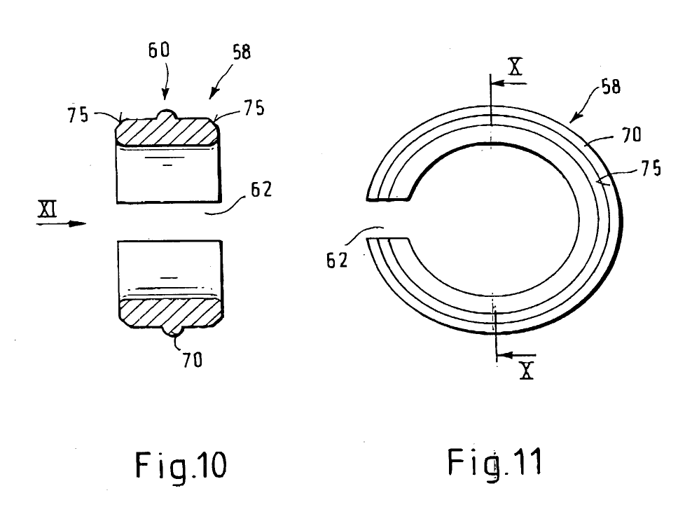

This sealing arrangement 54 is retained in the socket housing 10 axially in a plug removal direction (arrow 56) by means of a closing bushing 58. In this case, provision is made for the closing bushing 58 to be retained in an axially fixed manner directly in the socket housing 10 via locking means 60. A latching of the closing bushing 58 in the socket housing 10 is preferably provided as latching means 60. For this purpose, the closing bushing 58, also compare FIGS. 10 and 11 in this respect, is designed in a manner such that it can be deformed radially and elastically by means of a continuous slot-type interruption 62 with corresponding radial latching means being provided on the outer circumference of the closing bushing 58, and in the inner circumference of the socket housing 10. In the design according to FIG. 1 provision is made for the latching means to comprise a radially inwardly projecting bead-like annular bump 64 on the socket housing 10, and a radial annular depression 66 on the closing bushing 58. The radially inwardly projecting annular bump 64 means that the spacer ring 57 also has to be designed in a manner such that it can be deformed radially and elastically for insertion through a slot-type interruption.

In the case of the design which is to be preferred in this respect according to FIG. 2, provision is made for the locking means 60 to comprise a radially outwardly directed annular depression 68 in the socket housing 10 and a radial, bead-like annular bump 70 on the closing bushing 58. It is advantageous that within the socket housing 10 a free cross section is produced for insertion of the components of the sealing arrangement 54, and also of the spacer ring 57, which can thereby be designed such that it is not slotted. This provides a continuous bearing surface for each sealing ring 55. In this case, it is additionally advantageous if a further supporting ring 72 is arranged between the closing bushing 58 and the nearest sealing ring 55, it being possible for the supporting ring to be designed such that it is likewise advantageously unslotted and is circumferentially continuous. By this means, the sealing ring 55 is also protected on this side against being pressed axially into the slot-type interruption 62 of the closing bushing 58.

In order to facilitate the insertion of the closing bushing 58 into the socket housing 10, the closing bushing 58 has, at least on one side, a bevel as introductory slope 75 which automatically brings about the elastic radial latching purposes.

In contrast to the designs according to FIGS. 1 and 2, according to FIGS. 10 and 11, provision can be made for the closing bushing 58 to be of symmetrical design in the axial direction with regard to the position of its annular depression 66 and, in particular, its annular bump 70. This facilitates the installation since attention does not need to be focused on the orientation during insertion. There is, of course, a bevel 5 on both sides of slope 75.

As an alternative to the illustrated designs having latching, a direct, nonreleasable securing of the closing bushing 58 in the socket housing 10 may also be provided. For this purpose, the closing bushing 58, preferably provided with the annular depression 66 corresponding to FIG. 1, is designed such that it is unslotted and rigid radially and dimensionally stable. The securing then takes place after the insertion by means of a radial, plastic deformation of the socket housing 10 which is originally cylindrical in this region.

By means of its preferred means of fixing it in place, the closing bushing 58 also forms an axial stop (plug-in boundary) for the plug part 4 and its annular projection 8. In this case, the annular projection 8 can be retained in an essentially play-free manner between the closing bushing 58 and the retaining sections 18 of the retaining element 16.

As furthermore emerges from FIGS. 7 through 9, the retaining element 16 is preferably formed as a stamped and bent part of spring steel sheet. The retaining sections 18 are designed as spring arms 71 which protrude axially in the plug-in direction of the plug (arrow 44 in FIG. 2) in the manner of barbs and obliquely radially inward and, at their free ends, have bearing sections 73 which are bent outward through at least 90°.

In the case of the design illustrated, eight radially symmetrically arranged spring arms 71 or retaining sections 18 are provided. This results in a crown-like design. Furthermore, the retaining element 16 has, in each case in the region between the adjacent retaining sections 18 in the circumferential direction, fixing sections 74 which sit in the socket housing 10 in a manner such that they are fixed axially and radially in place. According to FIGS. 1 and 2, the fixing sections 74 are supported in the axial direction, firstly, on a radial inner surface formed in the region of the latching step 26 and, secondly, on an inner annular projection 76 in the region of the opening edge 48. The socket housing 10 is preferably produced as a single part from a metal blank by a multi-stage deep-drawing process, but it can also be formed from a formed metal section of pipe. This can be achieved by special forming by upsetting. In both designs, the mouth-side annular projection 76 can be formed by being rolled in.

The retaining sections 18 and the fixing sections 74 of the retaining element 16 emerge from an essentially annular base section 78 which, according to FIG. 8, has a continuous slot-type interruption 80 at one circumferential point. As a result, the retaining element 16 can also be deformed radially and elastically in order for it to be able to be inserted into the socket housing 10.

As furthermore emerges from FIGS. 11 and 2, the deep-drawn or formed socket housing 10 has a first section 82 having an internal cross section corresponding approximately to the external cross section of the plug part 4, a second section 84, which is expanded radially in comparison, for receiving the sealing arrangement 54, an adjoining conically expanded third section 86, an adjoining first cylindrical section 88, and a second cylindrical section 90 which is expanded in comparison. Arranged between the cylindrical sections 88 and 90 is a radial section 92 which firstly, forms the latching step 26 on the outside and secondly, forms the stop for the fixing sections 74 of the retaining element 161 on the inside. On the end side or mouth side, the second cylindrical section 90 merges into the annular projection 76 which has been rolled in.

While the above description constitutes the preferred embodiment of the present invention, it will be appreciated that the invention is susceptible to modification, variation and change without departing from the proper scope and fair meaning of the accompanying claims.

1. A receiving part of a fluid plug-in coupling comprising a socket housing having a plug-in opening for a plug part and having a retaining device for releasably fixing the plug part in place, the retaining device having a retaining element which is mounted in the socket housing and has one or more radially elastically deformable retaining sections for latching engagement behind a radial retaining step of the plug part, and a release element which is secured in an axially displaceable manner relative to the socket housing, the release element engaging by means of an inner release section in the plug-in opening and, for release purposes, acting against the retaining sections of the retaining element, and latching means for securing the release element are provided on the outer circumference of the socket housing.

2. The receiving part as claimed in claim 1 wherein the latching means comprises an outer, radial latching step of the socket housing and at least two radially resilient latching arms of the release element, which latching arms are distributed in a radially symmetrical manner over the circumference and engage axially over the socket housing and the latching step.

3. The receiving part as claimed in claim 2, wherein the release element formed as a single piece and comprising a hollow cylindrical inner sleeve joining the latching arms via a transition section.

4. The receiving part as claimed in claim 3, wherein the transition section comprises an end section which emerges radially from the release section and is essentially in the shape of an annular disk and merges into a hollow cylindrical circumferential section which coaxially surrounds the release section at a radial distance.

5. The receiving part as claimed in claim 4, wherein the circumferential section merges at its end edge, which points away from the end section, into the latching arms.

6. The receiving part as claimed in claim 4, wherein the circumferential section has axial slots on both sides of each latching arm in such a manner that the latching arms are extended in the direction of the end section.

7. The receiving part as claimed in claim 2, wherein the latching arms have, at their free ends, radially inwardly projecting latching lugs for interacting with the outer latching step of the socket housing in a form-fitting manner or in a fictional manner.

8. The receiving part as claimed in claim 2, wherein the outer latching arms protrude axially over the inner release section.

9. The receiving part as claimed in claim 3, wherein a clearance ensuring the axial movability of the release element is formed in the region of the transition section between the release element and the socket housing.

10. The receiving part as claimed in claim 9, further comprising a spring element arranged within the clearance in such a manner that the release element can be moved out of a spring-induced inoperative position into a release position counter to spring force.

11. The receiving part as claimed in claim 9, wherein a sealing element is arranged within the clearance.

12. The receiving part as claimed in claim 11, wherein the spring element and the sealing element are formed from a single annular element consisting of an elastic material of cellular rubber or the like.

13. The receiving part as claimed in claim 1, wherein the release element has a radial sealing lip so as to circumferentially support a circumferential surface of the plugged-in plug part.

14. The receiving part as claimed in claim 1, further comprising a sealing arrangement for circumferentially sealing the plugged-in plug part is arranged within the socket housing, the sealing arrangement being retained axially in a plug removal direction by means of a closing bushing, the closing bushing being retained in an axially fixed manner directly in the socket housing via a locking means.

15. The receiving part as claimed in claim 14, wherein a latching of the closing bushing in the socket housing is provided as locking means.

16. The receiving part as claimed in claim 15, wherein the closing bushing can be deformed radially and elastically by means of a continuous slot-type interruption with corresponding, radial latching means being formed on the outer circumference of the closing bushing and in the inner circumference of the socket housing.

17. The receiving part as claimed in claim 15, wherein the locking means comprise a radially inwardly projecting annular bump on the socket housing and a radial annular depression on the closing bushing.

18. The receiving part as claimed in claim 15, wherein the locking means comprise a radially outwardly directed annular depression in the socket housing and a radial annular bump on the closing bushing.

19. The receiving part as claimed in claim 14, wherein the sealing arrangement has two sealing rings which are spaced apart via a spacer ring.

20. The receiving part as claimed in claim 14, wherein an unslotted, circumferentially continuous supporting ring is arranged between the closing bushing and the sealing ring.

21. The receiving part as claimed in claim 1, wherein the retaining element is formed as a stamped and bent part of spring steel sheet, the retaining sections being designed as spring arms which protrude axially in the plug-in direction of the plug in the manner of barbs and obliquely radially inward.

22. The receiving part as claimed in claim 1, wherein the retaining element has, in each case in the region between the adjacent retaining sections in the circumferential direction, fixing sections which sit in the socket housing in a manner such that they are fixed axially and radially in place.

23. The receiving part as claimed in claim 22, wherein the retaining sections and the fixing sections emerge from an annular base section having a slot-type interruption.

24. The receiving part as claimed in claim 1, wherein the socket housing is formed as a single part from a formed section of pipe or from a deep-drawn metal blank.
